(19) United States
(12) Patent Application Publication
(10) Pub. No.: US 2003/0130091 A1
(43) Pub. Date: Jul. 10, 2003

(54) Method and device for issuing a feedback signal to the driver of a motor vehicle

(76) Inventor: Jurgen Wafzig, Eriskirch (DE)

Correspondence Address: DAVIS & BUJOLD, P.L.L.C., FOURTH FLOOR, 500 N. COMMERCIAL STREET, MANCHESTER, NH, 03101-1151, US

(21) Appl. No.: 10/276,571

(22) PCT Filed: May 19, 2001
(86) PCT No.: PCT/EP01/05758

(30) Foreign Application Priority Data
May 27, 2000 (DE) 100 26 408.0

(51) Int. Cl. F16H 59/48; G06F 7/00; G06F 19/00

(52) U.S. Cl. 477/120; 701/60

(57) ABSTRACT

A method and device are described for issuing a feedback signal to the driver of a motor vehicle as soon as an admissible constant load limit of a shifting element in a motor vehicle transmission, especially a starting clutch in an automatic transmission, is exceeded. The feedback signal to the driver takes the form of a haptic signal via an accelerator pedal of the motor vehicle as pulsated motion of the throttle pedal.

### FIELD OF THE INVENTION

This invention relates to a method, the same and a device for carrying out the method, for issuing a feedback signal to the driver of a motor vehicle when an admissible load limit of a shifting element in a transmission of a motor vehicle is exceeded, especially of a starting clutch in an automated transmission, is exceeded.

### BACKGROUND OF THE INVENTION

Transmissions of motor vehicles are subject to a constant further development. Thus, they must today be made increasingly more compact and yet be more comfortable during operation and be produced at more reasonable cost than their predecessors. It results herefrom that, for example, in automatic transmissions the hydraulic converter provided to reinforce the starting torque is replaced by a multi-disc clutch, or that a selector transmission is equipped with automated clutches, or also that manually operated transmissions are completely automated. Due to the structural design of the individual components, specially of the starting element, it must be ensured in the usual average loads, and not in unusual, highly loaded individual operations such as starting with too high a trailer load, stall speed, etc., that especially the starting element be always reliably operated. Hence it becomes required to issue to the driver a feedback when the admissible constant load limit of a component, in particular the starting element, has been exceeded.

DE 198 15 259 A1, for example, has disclosed a motor vehicle having a device for control of an automated clutch. This motor vehicle stands out by the fact that, for example, in case of too high an energy input or too high a temperature of the friction lining, a warning function to the driver is implemented. This takes place in three time phases wherein in the first time phase the clutch torque is unaffectedly controlled, in a second phase the torque is variously controlled in time and in a third phase the torque is increased until the rotational speed of the engine is below a threshold value.

The problem on which this invention is based is to outline a method and a device of the above mentioned kind which make possible an easy, reliable and inexpensive feedback of a signal to the driver.

According to the invention this problem is solved by a method and a device according to the features stated in claims 1 and 6. Advantageous developments are indicated in the dependent claims.

### SUMMARY OF THE INVENTION

After it has been established in a transmission that an admissible constant load limit of a starting and/or shifting element, especially of a starting clutch in an automated transmission, has been exceeded, the feedback is issued to the driver as haptic signal via an accelerator pedal of the motor vehicle. The driver thus advantageously receives by means of an accelerator pedal a quick and noticeable feedback concerning an inadmissible operating state.

The signal occurs, for example, as pulsated movement of an accelerator pedal so that the driver advantageously perceives the signal directly without being distracted, for example, by an optical indication in the vehicle.

In a specially advantageous development of the invention, it is proposed that the signal be issued to the driver by means of the throttle pedal, since those intolerable states occur mostly in the traction operations of a vehicle an the driver usually keeps a foot on the throttle pedal during the traction operation.

The pulsated movement of the pedal can here be produced mechanically, pneumatically or specially in hydraulic manner.

In case of an electrically actuatable pedal, for example, an E-throttle pedal, the pulsated movement advantageously is likewise electrically produced. It can occur, for example, via an electric motor with an eccentric.

### DETAILED DESCRIPTION OF THE INVENTION

According to a preferred embodiments a method for issuing a feedback signal to the driver of a motor vehicle with a transmission, when an admissible load limit of a starting and shifting element in the motor vehicle transmission is exceeded, especially the starting clutch in an automated transmission, wherein the feedback takes place as a haptic signal via an accelerator pedal of the motor vehicle. The signal may take place on a throttle pedal or be given as pulsated movement of an accelerator pedal. The pulsated movement of the pedal may be produced mechanically, pneumatically, hydraulically or in an electrically actuatable pedal such as an E-throttle pedal the pulsated movement may be electrically produced.

The invention also provides a device for issuing a feedback signal to the driver of a motor vehicle when an admissible load limit of a starting and shifting element in the motor vehicle transmission is exceeded, especially the starting clutch in an automated transmission, for carrying out the above method, wherein the feedback is issued as haptic signal via an accelerator pedal of the motor vehicle. The accelerator pedal, especially the throttle pedal, may carry out a pulsated movement produced mechanically pneumatically, hydraulically or in an electrically actuatable pedal, for example, in am E-throttle pedal, may be electrically produced. The pulsated movement of the pedal is produced via an electric motor with eccentric.

1. Method for issuing a feedback signal to the driver of a motor vehicle when an admissible load limit of a starting and/or shifting element in a motor vehicle transmission, specially the starting clutch in an automated transmission, is exceeded, characterized in that the feedback takes place as haptic signal via an accelerator pedal of the motor vehicle.

2. Method according to claim 1, characterized in that the signal is given as pulsated movement of an accelerator pedal.

3. Method according to claims 1 and 2, characterized in that the signal takes place on the throttle pedal.

4. Method according to claim 2 or 3, characterized in that the pulsated movement of the pedal is produced mechanically, pneumatically, or hydraulically.

5. Method according to claim 2 or 3, characterized in that in an electrically actuatable pedal such as an E-throttle pedal the pulsated movement is electrically produced.

6. Device for issuing a feedback signal to the driver of a motor vehicle when an admissible load limit of a starting and/or shifting element in a motor vehicle transmission, especially the starting clutch in an automated transmission, is exceeded, for carrying out a method according to one of the preceding claims, characterized in that the feedback is issued as haptic signal via an accelerator pedal of the motor vehicle.

7. Device according to claim 6, characterized in that the accelerator pedal, especially the throttle pedal, carries out a pulsated movement.

8. Device according to claim 7, characterized in that the pulsated movement of the pedal is produced mechanically pneumatically, or hydraulically.

9. Device according to clam 7, characterized in that the pulsated movement in an electrically actuatable pedal, for example, in am E-throttle pedal, is electrically produced.

10. Device according to claim 9, characterized in that the pulsated movement of the pedal is produced via an electric motor with eccentric.
